(19) United States
(12) Patent Application Publication
(10) Pub. No.: US 2024/0052969 A1
(43) Pub. Date: Feb. 15, 2024

(54) Slide Rail Assembly for Display Support, Slide Rail Apparatus, and Display Support

(71) Applicant: NINGBO TUOTUO RIVER DESIGN COMPANY, Ningbo (CN)

(72) Inventors: Xiaodong YOU, NINGBO (CN); Hongjun WANG, NINGBO (CN)

(21) Appl. No.: 18/226,801

(22) Filed: Jul. 27, 2023

(30) Foreign Application Priority Data
Aug. 15, 2022 (CN) 202222159491.7

(51) Int. Cl. F16M 11/04; F16M 11/10

(52) U.S. Cl. CPC F16M 11/045; F16M 11/041; F16M 11/10; F16M 2200/027; F16M 2200/024

(57) ABSTRACT

The embodiment provides a slide rail assembly for a display support, a slide rail apparatus, and the display support. The slide rail assembly for the display support includes a slide rail; a first sliding piece, slidably arranged on the slide rail, the first sliding piece being configured to be connected with a fixing base; and a second sliding piece, slidably arranged on the slide rail, the second sliding piece and the first sliding piece being respectively located on two opposite sides of the slide rail, and the second sliding piece being configured to be connected with a panel. The technical solution of the embodiment solves the problem in the related art that the position adjusting range of a display is difficult to meet the customer needs.

### CROSS-REFERENCE TO RELATED APPLICATION(S)

The present disclosure claims the priority of Chinese Application No. 202222159491.7, filed on the Chinese Patent Office on Aug. 15, 2022, and entitled “Slide rail assembly for display support, slide rail apparatus, and display support”.

### TECHNICAL FIELD

The invention relates to the technical field of display supports, in particular to a slide rail assembly for a display support, a slide rail apparatus, and the display support.

### BACKGROUND

In the related art, a slide rail assembly for a display support is generally of a single slide rail structure, and a display only moves one stroke relative to a fixing base, which makes the range of movement of the display quite limited, resulting in the problem that the position adjusting range of the display is difficult to meet the customer's needs.

### SUMMARY

The invention provides a slide rail assembly for a display, a slide rail apparatus, and a display support, so as to solve the problem in the related art that the position adjusting range of a display is difficult to meet the customer needs.

In order to achieve the above purpose, according to one aspect of the embodiments, a slide rail assembly for a display support is provided, which includes a slide rail; a first sliding piece, slidably arranged on the slide rail, the first sliding piece being configured to be connected with a fixing base; and a second sliding piece, slidably arranged on the slide rail, the second sliding piece and the first sliding piece being respectively located on two opposite sides of the slide rail, and the second sliding piece being configured to be connected with a panel.

In some embodiments, the first sliding piece is provided with a first chute, and at least part of the slide rail is in sliding fit with the first chute.

In some embodiments, the second sliding piece is provided with a second chute, and part of the slide rail is in sliding fit with the second chute.

In some embodiments, the slide rail is provided with a third chute, and the second sliding piece is slidably arranged in the third chute.

In some embodiments, the slide rail includes a first body and a second body which are connected; wherein the first body is in sliding fit with the first chute, and the second body is in sliding fit with the second chute.

In some embodiments, the first body and the second body are staggered in a height direction of the slide rail.

In some embodiments, the slide rail assembly includes a plurality of first sliding pieces which are sequentially nested, any two adjacent first sliding pieces being in sliding fit; and/or, the slide rail assembly includes a plurality of second sliding pieces which are sequentially nested, any two adjacent second sliding pieces being in sliding fit.

In some embodiments, when the slide rail assembly includes the plurality of first sliding pieces, lengths of the plurality of first sliding pieces are different.

In some embodiments, the slide rail assembly further includes a wear-resistant part arranged on the first sliding piece, the wear-resistant part being located between the first sliding piece and the slide rail; or, the slide rail assembly further includes at least one locking piece, the locking piece penetrating through at least one of the first sliding piece and the second sliding piece, and under the action of an external force, the locking piece having a locking position abutting against the slide rail and an unlocking position away from the slide rail.

In some embodiments, the slide rail is provided with a slot, and the elongated hole extends in a length direction of the slide rail. The slide rail assembly further includes a limiting piece, a first end of the limiting piece is connected with the first sliding pieces, and a second end of the limiting piece is slidably arranged in the slot.

According to another aspect of the embodiments, a slide rail apparatus is also provided, which includes: the slide rail assembly; a quick-release assembly, the slide rail assembly being detachably connected with the fixing base through the quick-release assembly; and a limiting assembly, connected with the slide rail assembly, the limiting assembly being in limiting fit with the fixing base to limit a rotation of the slide rail assembly relative to the fixing base.

In some embodiments, the quick-release assembly includes: a clamping piece, connected with the first sliding piece, the clamping piece protruding towards a side away from the first sliding piece; a connecting piece, connected with the fixing base, the connecting piece defining a clamping cavity, and the clamping piece being in clamping fit with the clamping cavity; a connecting body, the connecting body being provided with an open groove, and an opening of the open groove being configured to enable the clamping piece to slide in or out; and an elastic element, connected with the connecting body, the elastic element being located on a side of the opening, and the elastic element and an inner wall of the open groove enclosing the clamping cavity.

In some embodiments, the limiting assembly includes: a rotation stopping structure, connected with the first sliding pieces, the rotation stopping structure defining a mounting cavity for accommodating the quick-release assembly; and two locking structures, respectively penetrating through two opposite sides of the rotation stopping structure, and under the action of an external force, each locking structure being movably arranged relative to the rotation stopping structure, so that the each locking structure has a locking state abutting against the fixing base and an unlocking state away from the fixing base.

According to another aspect of the embodiments, a display support is also provided, which includes a fixing base, a panel, and the slide rail apparatus, the slide rail apparatus being configured to connect the panel and the fixing base.

Through applying the technical solutions of the embodiments, by arranging the first sliding piece and the second sliding piece which are slidably arranged relative to the slide rail respectively, the slide rail drives the second sliding piece to slide a preset stroke relative to the first sliding piece and the fixing base, and the second sliding piece is able to drive the panel to slide another preset stoke relative to the slide rail, so that the panel slides two preset strokes relative to the fixing base, so as to increase the range of movement of the panel, and then the position adjusting range of the display meets the customer needs.

### BRIEF DESCRIPTION OF THE DRAWINGS

The accompanying drawings of the specification, which constitute a part of the invention, are intended to provide a further understanding of the invention, and the exemplary embodiments of the invention and the description thereof are intended to explain the invention and do not constitute an undue limitation on the invention. In the accompanying drawings:

FIG. 1 shows a main view of Embodiment 1 of a display support of the invention;

FIG. 2 shows a left view of the display support in FIG. 1;

FIG. 3 shows a rear view of the display support in FIG. 1;

FIG. 4 shows a schematic diagram of a breakdown structure of the display support in FIG. 1 in one direction;

FIG. 5 shows a schematic diagram of a breakdown structure of the display support in FIG. 1 in another direction;

FIG. 6 shows a main view of Embodiment 2 of the display support of the invention;

FIG. 7 shows a left view of the display support in FIG. 6;

FIG. 8 shows a rear view of the display support in FIG. 6; and

FIG. 9 shows a schematic diagram of a breakdown structure of the display support in FIG. 6.

Herein, the above accompanying drawings include the following reference signs.

2. Fixing base; 3. Panel; 10. Slide rail; 11. Third chute; 12. First body; 13. Second body; 14. Stop plate; 20. First sliding piece; 21. First chute; 30. Second sliding piece; 31. Second chute; 40. Wear-resistant part; 50. Locking piece; 61. Slot; 62. Limiting piece; 70. Quick-release assembly; 71. Clamping piece; 72. Connecting piece; 73. Open groove; 74. Elastic element; 80. Rotation stopping structure; 81. Mounting cavity; and 82. Locking structure.

### DETAILED DESCRIPTION OF THE EMBODIMENTS

It is to be noted that the embodiments in the invention and features in the embodiments may be combined with each other without conflict. The invention is described below with reference to the accompanying drawings and in conjunction with the embodiments in detail.

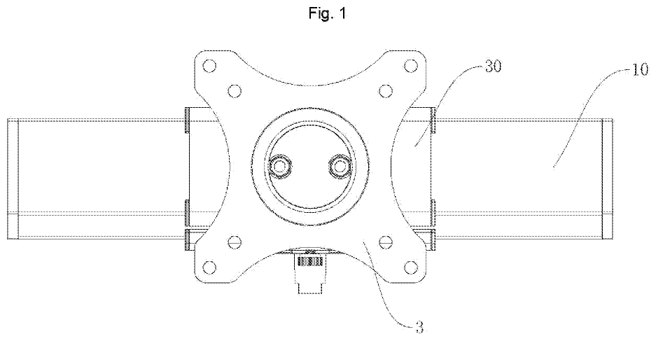

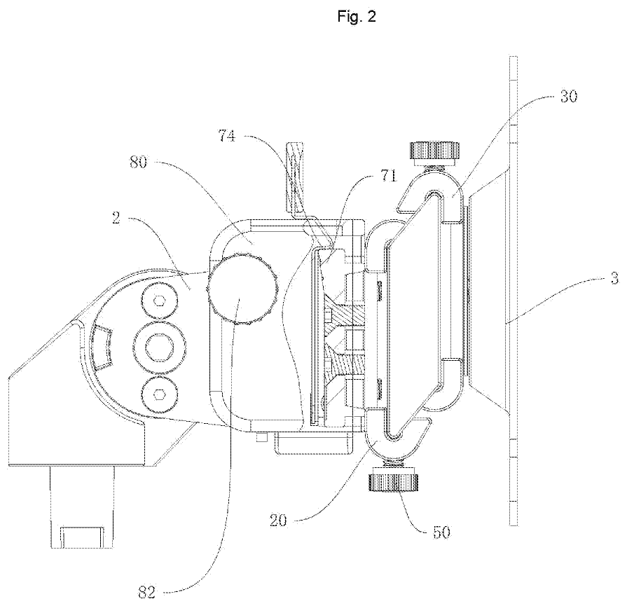

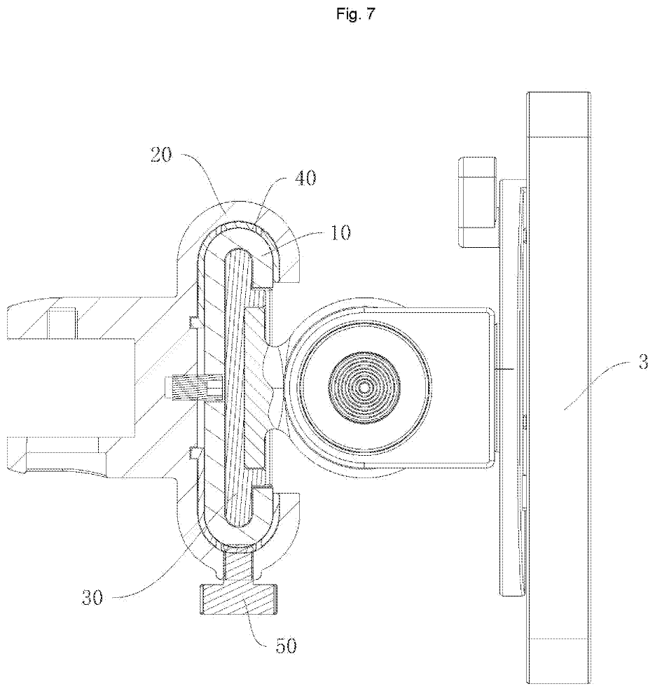

As shown in FIG. 1, FIG. 2, FIG. 4, FIG. 7, and FIG. 9, the embodiments of the invention provide a slide rail assembly for a display support. The slide rail assembly for the display support includes a slide rail 10, a first sliding piece 20, and a second sliding piece 30. The first sliding piece 20 is slidably arranged on the slide rail 10, and the first sliding piece 20 is configured to be capable of connecting with a fixing base 2. The second sliding piece 30 is slidably arranged on the slide rail 10, the second sliding piece 30 and the first sliding piece 20 are respectively located on two opposite sides of the slide rail 10, and the second sliding piece 30 is configured to be connected with a panel 3.

In the above technical solution, by arranging the first sliding piece 20 and the second sliding piece 30 which are slidably arranged relative to the slide rail 10, respectively, the slide rail 10 is able to drive the second sliding piece 30 to slide a preset stroke relative to the first sliding piece 20 and the fixing base 2, and the second sliding piece 30 drive the panel 3 to slide another preset stoke relative to the slide rail 10, so that the panel 3 slides two preset strokes relative to the fixing base 2, so as to increase the movement range of the panel 3, and then the position adjusting range of a display meets the customer needs.

It is to be noted that in the embodiments of the invention, the preset stroke is the same as the length of the slide rail 10.

It is to be noted that in the embodiments of the invention, the panel 3 is configured to mount the display, and the fixing base 2 is mounted on a support frame to support the display.

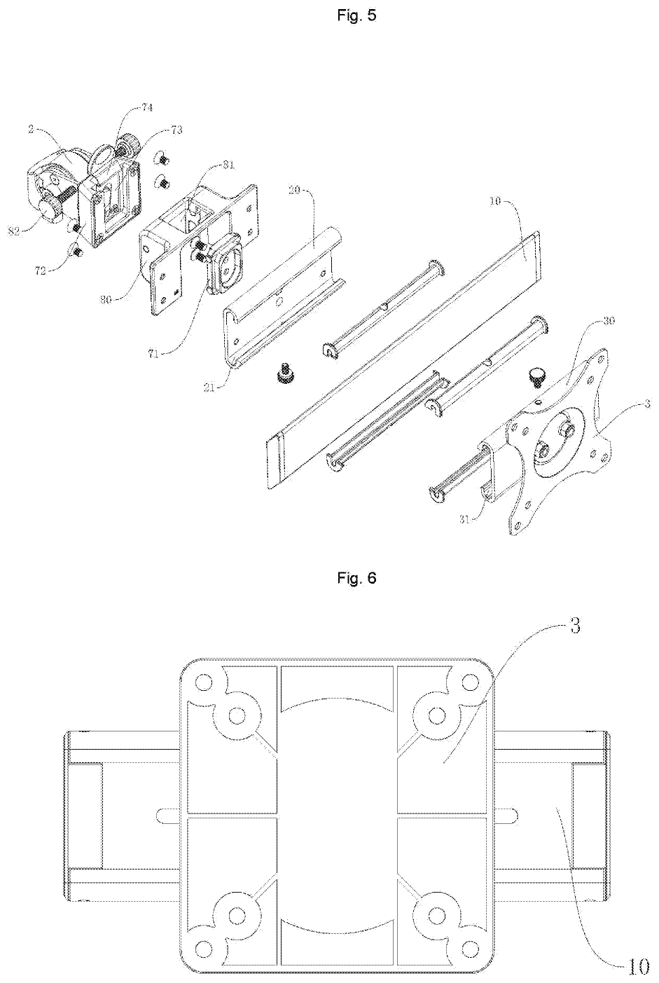

As shown in FIG. 4 and FIG. 5, in the embodiments of the invention, the first sliding piece 20 is provided with a first chute 21, and at least part of the slide rail 10 is in sliding fit with the first chute 21. In this way, the first sliding piece 20 sleeves the slide rail 10, and the first sliding piece 20 slides a preset stroke relative to the slide rail 10.

Specifically, in the embodiments of the invention, the slide rail assembly includes a plurality of sequentially nested second sliding pieces 20, any two adjacent second sliding pieces 20 being in sliding fit. In this way, the ultimate displacement of the slide rail 10 relative to the fixing base 2 is increased to increase a sliding stroke of the slide rail assembly, thereby increasing the range of movement of the panel 3, and then the position adjusting range of the display meets the customer needs.

In embodiments of the invention, the plurality of first sliding pieces 20 have different lengths. In this way, the first sliding piece 20 with a shorter length slides on the first sliding piece 20 with a longer length, and limiting pieces are conveniently arranged at the opposite ends of the first sliding piece 20 with the longer length, so as to prevent the first sliding piece 20 with the shorter length from falling off from the first sliding piece 20 with the longer length.

In some embodiments, the first sliding piece 20 with the shorter length and the first sliding piece 20 with the longer length are arranged alternately.

As shown in FIG. 7, in the embodiments of the invention, the slide rail assembly further includes a wear-resistant part 40 arranged on the first sliding piece 20, the wear-resistant parts 40 being located between the first sliding piece 20 and the slide rail 10.

Through the above arrangement, the wear-resistant part 40 prevents wear between the first sliding piece 20 and the slide rail 10 when the first sliding piece 20 slides on the slide rail 10, so as to avoid the first sliding piece 20 loosening relative to the slide rail 10 due to wear, thereby avoiding affecting the relative sliding between the first sliding piece 20 and the slide rail 10.

Specifically, as shown in FIG. 9, in the embodiments of the invention, the slide rail assembly includes two wear-resistant parts, the two wear-resistant parts being arranged in an up and down direction, and the two wear-resistant parts respectively corresponding to upper and lower ends of the first sliding pieces 20.

### Embodiment 1

As shown in FIG. 4 and FIG. 5, in the embodiments of the invention, the second sliding piece 30 is provided with a second chute 31, and part of the slide rail 10 is in sliding fit with the second chute 31. In this way, the second sliding piece 30 is enabled to sleeve the slide rail 10, and the second sliding piece 30 is able to slide a preset stroke relative to the slide rail 10, so that the second sliding piece 30 drives the panel 3 to slide two preset strokes relative to the first sliding piece 20, and then the position adjusting range of the display meets the customer needs.

As shown in FIG. 4, in Embodiment 1 of the invention, the slide rail 10 includes a first body 12 and a second body 13 which are connected. The first body 12 is in sliding fit with the first chute 21, and the second body 13 is in sliding fit with the second chute 31. In this way, the mutual interference of the first sliding piece 20 and the second sliding piece 30 during sliding is avoided.

Specifically, as shown in FIG. 4, in Embodiment 1 of the invention, the slide rail assembly further includes two stop plates 14 respectively located at two opposite ends of the slide rail 10 in a sliding direction, each stop plate 14 being configured to connect the first body 12 and the second body 13, and the stop plates 14 also preventing the first sliding piece 20 and the second sliding piece 30 from sliding out of the slide rail 10 during sliding.

As shown in FIG. 2 and FIG. 4, in Embodiment 1 of the invention, the first body 12 and the second body 13 are staggered in a height direction of the slide rail 10.

Through the above arrangement, a gap between the first body 12 and the second body 13 is reduced when the first sliding piece 20 and the second sliding piece 30 do not interfere with each other, so as to reduce a distance between the panel 3 and the fixing base 2, so that the whole display support is more compact and stable in a horizontal direction.

It is to be noted that in the embodiments of the invention, the height direction of the slide rail 10 refers to a vertical direction in FIG. 4.

Specifically, in Embodiment 1 of the invention, the slide rail assembly includes the plurality of sequentially nested second sliding pieces 30, any two adjacent second sliding pieces 30 are in sliding fit.

In the technical solution, each second sliding piece 30 is provided with the second chute 31, and the plurality of second sliding pieces 30 are sequentially nested, so that the ultimate displacement of the panel 3 relative to the slide rail 10 is increased, thereby increasing the range of movement of the panel 3, and then the position adjusting range of the display meets the customer needs.

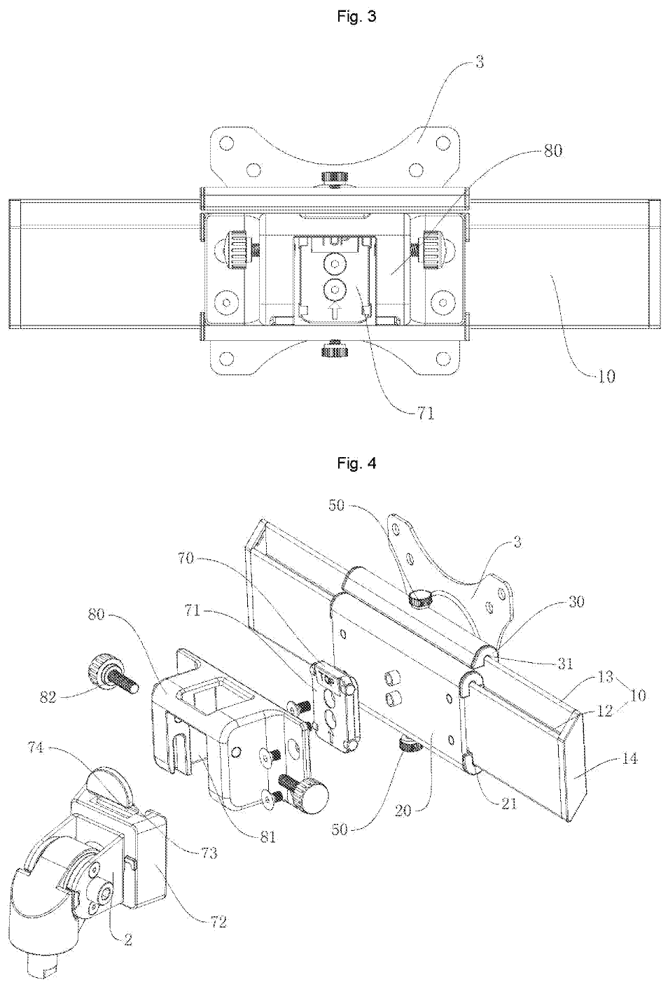

As shown in FIG. 2 to FIG. 4, in Embodiment 1 of the invention, the slide rail assembly further includes two locking pieces 50, the locking pieces 50 penetrating through the first sliding piece 20 and the second sliding pieces 30, and under the action of an external force, the locking pieces 50 having a locking position abutting against the slide rail 10 and an unlocking position away from the slide rail 10.

In the above technical solution, when the display is adjusted to a position that meets the customer needs, the locking pieces 50 abut against the slide rail 10 to fix the positions of the first sliding piece 20 and/or the hovering positions of the second sliding piece 30, so as to fix the hovering position of the display. When the position of the display needs to be adjusted, the locking pieces 50 are away from the slide rail 10 to adjust the position of the first sliding piece 20 and/or the position of the second sliding piece 30, so as to adjust the position of the display.

Specifically, in Embodiment 1 of the invention, the first sliding piece 20 and the second sliding piece 30 are both provided with threaded holes, and the locking pieces and the threaded holes are in screw-thread fit, so that the locking pieces 50 are close to or far away from the slide rail 10 by screwing the locking pieces 50.

### Embodiment 2

As shown in FIG. 6 to FIG. 9, Embodiment 2 differs from Embodiment 1 in that the slide rail 10 is provided with a third chute 11, and the second sliding piece 30 is slidably arranged in the third chute 11.

Through the above arrangement, the second sliding piece 30 is able to slide in the third chute 11, and the second sliding piece 30 is able to slide a preset stroke relative to the slide rail 10, so that the second sliding piece 30 drives the panel 3 to slide two preset strokes relative to the first sliding piece 20, and then the position adjusting range of the display meets the customer needs.

As shown in FIG. 9, in Embodiment 2 of the invention, the slide rail 10 is provided with an elongated hole 61, and the elongated hole 61 extends in a length direction of the slide rail 10. The slide rail assembly further includes a limiting piece 62, one end of the limiting piece 62 is connected with the first sliding piece 20, and the other end of the limiting piece 62 is slidably arranged in the elongated hole 61.

Through the above arrangement, the elongated hole 61 not only guides the limiting piece 62, but inner wall surfaces of both sides of the elongated hole 61 also limit the movement of the limiting piece 62, so as to limit and guide the first sliding piece 20 to prevent the first sliding piece 20 from falling off the slide rail 10.

Specifically, as shown in FIG. 9, in Embodiment 2 of the invention, the slide rail assembly further includes two stop plates 14 respectively located at two opposite ends of the slide rail 10 in a sliding direction, the stop plates 14 are fixed to the slide rail 10 through set screws, and each stop plate 14 is able to prevent the second sliding piece 30 from sliding out of the slide rail 10 during sliding.

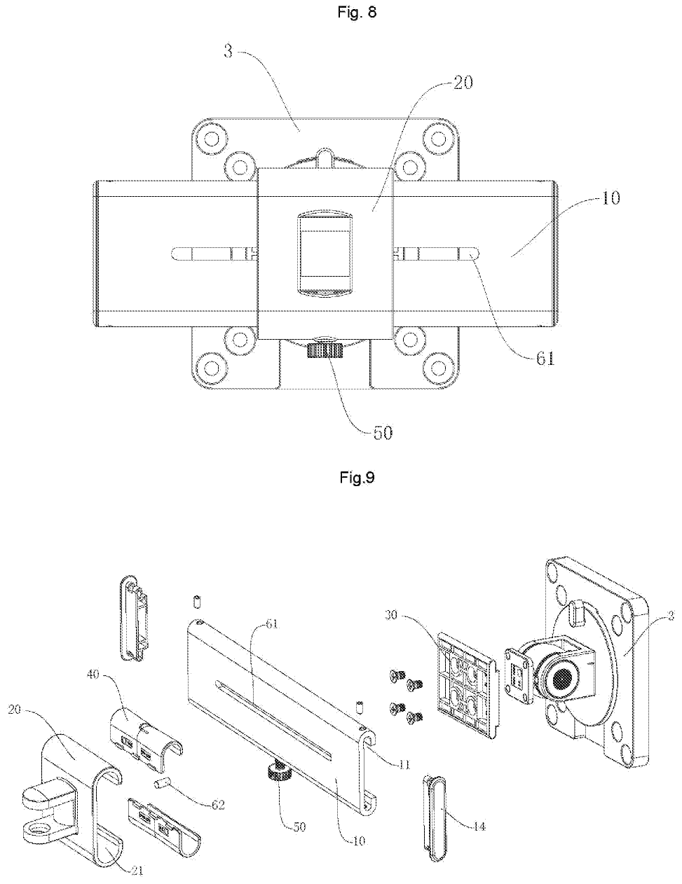

As shown in FIG. 8 and FIG. 9, in Embodiment 2 of the invention, the slide rail assembly further includes one locking piece 50, the locking piece 50 penetrating through the first sliding piece 20, and under the action of an external force, the locking piece 50 having a locking position abutting against the slide rail 10 and an unlocking position away from the slide rail 10.

In the above technical solution, when the display is adjusted to a position that meets the customer needs, the locking piece 50 abuts against the slide rail 10 to fix the position of the first sliding piece 20, so as to fix the position of the display. When the position of the display needs to be adjusted, the locking piece 50 is away from the slide rail 10 to adjust the position of the first sliding piece 20, so as to adjust the position of the display.

Specifically, as shown in FIG. 9, in Embodiment 2 of the invention, the second sliding piece 30 is a slider, which is made of plastic, and the slide rail 10 is made of aluminum. Through the frictional force generated by the relative sliding of the slider and the slide rail 10, the slider is kept in certain positions.

Other structures of Embodiment 2 of the invention are the same as those of Embodiment 1, which will not be elaborated herein.

As shown in FIG. 2 to FIG. 5, the embodiments of the invention also provide a slide rail apparatus. The slide rail apparatus includes the slide rail assembly, a quick-release assembly 70 and a limiting assembly. The slide rail assembly is detachably connected with the fixing base 2 through the quick-release assembly 70. The limiting assembly is connected with the slide rail assembly, and the limiting assembly is in limiting fit with the fixing base 2 to limit the rotation of the slide rail assembly relative to the fixing base 2.

Through the above arrangement, the slide rail assembly is detachably connected with the fixing base 2 through the quick-release assembly 70, so that the slide rail assembly is matched with different fixing bases 2 to increase the universality of the slide rail assembly. The limiting assembly prevents the rotation of the slide rail assembly relative to the fixing base 2, so that the slide rail assembly of the display is kept in a horizontal position, so as to facilitate the sliding of the first sliding piece 20 and the second sliding piece 30.

The slide rail apparatus has all the advantages of the slide rail assembly, which will not be elaborated herein.

As shown in FIG. 4 and FIG. 5, in the embodiments of the invention, the quick-release assembly 70 includes a clamping piece 71 and a connecting piece 72. The clamping piece 71 is connected with the first sliding piece 20, and the clamping piece 71 protrudes towards the side away from the first sliding piece 20. The connecting piece 72 is connected with the fixing base 2, the connecting piece 72 defines a clamping cavity, and the clamping piece 71 is in clamping fit with the clamping cavity.

Through the above arrangement, the quick-release between the clamping piece 71 and the connecting piece 72 is realized, so that the slide rail assembly is quickly connected with the fixing base 2 in a quick-release manner, which is convenient for the disassembly and replacement of the slide rail assembly.

As shown in FIG. 4 and FIG. 5, in the embodiments of the invention, the quick-release assembly 72 includes a connecting body and an elastic element 74. The connecting body is provided with an open groove 73, and an opening of the open groove 73 is configured to enable the clamping piece 71 to slide in or out. The elastic element 74 is connected to the connecting body, the elastic element 74 is located on one side of the opening, and the elastic element 74 and an inner wall of the open groove 73 enclose the clamping cavity.

Through the above arrangement, when the slide rail assembly is mounted, the clamping piece 71 pushes the elastic element 74 and slides into the open groove 73 from the opening of the open groove 73, when the clamping piece 71 slides into the open groove 73, the force of pushing the elastic element 74 disappears, and the elastic element 74 restores the original position, so as to limit the clamping piece 71, thereby fixing the slide rail assembly.

As shown in FIG. 4 and FIG. 5, in the embodiments of the invention, the quick-release assembly includes a rotation stopping structure 80 and two locking structures 82. The rotation stopping structure 80 is connected with the first sliding piece 20, and the rotation stopping structure 80 defines a mounting cavity 81 for accommodating the quick-release assembly 70. The two locking structures 82 respectively penetrate through two opposite sides of the rotation stopping structure 80, and under the action of an external force, the locking structures 82 are movably arranged relative to the rotation stopping structure 80, so that the locking structures 82 have a locking state abutting against the fixing base 2 and an unlocking state away from the fixing base 2.

Through the above arrangement, the rotation stopping structure 80 is connected with the slide rail assembly, and the locking structures 82 penetrate through the rotation stopping structure 80 to abut against the fixing base 2. In this way, the rotation of the quick-release assembly relative to the fixing base 2 is prevented, so that the rotation of the slide rail assembly relative to the fixing base 2 is prevented, and the slide rail assembly is kept in a horizontal position, which makes the first sliding piece 20 and the second sliding piece 30 slide more smoothly.

In an embodiment, the space size of the mounting cavity 81 is adjusted by hand screwing the locking structures 82, so that the rotation stopping structure 80 adapts to most of the fixing bases 2, thereby increasing the universality of the rotation stopping structure 80.

Specifically, in the embodiments of the invention, the rotation stopping structure 80 is provided with threaded holes, and the locking structures 82 and the threaded holes are in screw-thread fit, so that the locking structures 82 are close to or far away from the fixing base 2 by screwing the locking structures 82.

In the embodiments of the invention, the rotation stopping structure 80 is fixed to the first sliding piece 20 by countersunk head screws. The clamping piece 71 is fixed to the second sliding piece 30 by countersunk head screws.

As shown in FIG. 2, in one embodiment of the invention, a display support is also provided. The display support includes the fixing base 2, the panel 3, and the slide rail apparatus, the slide rail apparatus is configured to connect the panel 3 and the fixing base 2.

In the embodiments of the invention, the panel 3 is provided with two arc-shaped grooves, and screws connected with the second sliding piece 30 penetrate through the arc-shaped grooves, so that panel 3 rotates in a certain angle range, thereby adjusting the angle of the display.

The display support has all the advantages of the slide rail apparatus, which will not be elaborated herein.

From the above description, it can be seen that the above embodiments of the invention has the following technical effects that: by arranging the first sliding pieces and the second sliding pieces which are slidably arranged relative to the slide rail, respectively, the slide rail drives the second sliding pieces to slide a preset stroke relative to the first sliding pieces and the fixing base, and the second sliding pieces drive the panel to slide another preset stoke relative to the slide rail, so that the panel slides two preset strokes relative to the fixing base, so as to increase the range of movement of the panel, and then the position adjusting range of the display meets the customer needs.

The above are only some embodiments of the invention and are not intended to limit the invention. For those skilled in the art, the invention may have various modifications and variations. Any modifications, equivalent substitutions, improvements, etc. within the spirit and scope of the invention shall fall within the scope of protection of the invention.

What claimed is:

1. A slide rail assembly fora display support, comprising:
a slide rail;
a first sliding piece, slidably arranged on the slide rail, the first sliding pieces being configured to be connected with a fixing base; and
a second sliding piece, slidably arranged on the slide rail, the second sliding piece and the first sliding piece being respectively located on two opposite sides of the slide rail, and the second sliding piece being configured to be connected with a panel.

2. The slide rail assembly for the display support according to claim 1, wherein the first sliding piece is provided with a first chute, and at least part of the slide rail is in sliding fit with the first chute.

3. The slide rail assembly for the display support according to claim 2, wherein the second sliding piece is provided with a second chute, and part of the slide rail is in sliding fit with the second chute.

4. The slide rail assembly for the display support according to claim 2, wherein the slide rail is provided with a third chute, and the second sliding piece is slidably arranged in the third chute.

5. The slide rail assembly for the display support according to claim 3, wherein the slide rail comprises a first body and a second body which are connected, wherein the first body is in sliding fit with the first chute, and the second body is in sliding fit with the second chute.

6. The slide rail assembly for the display support according to claim 5, wherein the first body and the second body are staggered in a height direction of the slide rail.

7. The slide rail assembly for the display support according to claim 1, wherein the slide rail assembly comprises a plurality of first sliding pieces which are sequentially nested, any two adjacent first sliding pieces being in sliding fit; and/or,
the slide rail assembly comprises a plurality of second sliding pieces which are sequentially nested, any two adjacent second sliding pieces being in sliding fit.

8. The slide rail assembly for the display support according to claim 7, wherein when the slide rail assembly comprises the plurality of first sliding pieces, lengths of the plurality of first sliding pieces are different.

9. The slide rail assembly for the display support according to claim 1, wherein the slide rail assembly further comprises a wear-resistant part arranged on the first sliding piece, the wear-resistant part being located between the first sliding piece and the slide rail; or,
the slide rail assembly further comprises at least one locking piece, the locking piece penetrating through at least one of the first sliding piece and the second sliding piece, and under the action of an external force, the locking piece having a locking position abutting against the slide rail and an unlocking position away from the slide rail.

10. The slide rail assembly for the display support according to claim 1, wherein the slide rail is provided with an elongated hole, and the elongated hole extends in a length direction of the slide rail; and
the slide rail assembly further comprises a limiting piece, a first end of the limiting piece being connected with the first sliding piece, and a second end of the limiting piece being slidably arranged in the elongated hole.

11. A slide rail apparatus, comprising:
the slide rail assembly according to claim 1;
a quick-release assembly, the slide rail assembly being detachably connected with the fixing base through the quick-release assembly; and
a limiting assembly, connected with the slide rail assembly, the limiting assembly being in limiting fit with the fixing base to limit a rotation of the slide rail assembly relative to the fixing base.

12. The slide rail apparatus according to claim 11, wherein the quick-release assembly comprises:
a clamping piece, connected with the first sliding piece, the clamping piece protruding towards a side away from the first sliding piece;
a connecting piece, connected with the fixing base, the connecting piece defining a clamping cavity, and the clamping piece being in clamping fit with the clamping cavity;
a connecting body, the connecting body being provided with an open groove, and an opening of the open groove being configured to enable the clamping piece to slide in or out; and
an elastic element, connected with the connecting body, the elastic element being located on a side of the opening, and the elastic element and an inner wall of the open groove enclosing the clamping cavity.

13. The slide rail apparatus according to claim 11, wherein the limiting assembly comprises:
a rotation stopping structure, connected with the first sliding piece, the rotation stopping structure defining a mounting cavity for accommodating the quick-release assembly; and
two locking structures, respectively penetrating through two opposite sides of the rotation stopping structure, and under the action of an external force, each locking structure being movably arranged relative to the rotation stopping structure, so that the each locking structure has a locking state abutting against the fixing base and an unlocking state away from the fixing base.

14. A display support, comprising the fixing base, the panel, and the slide rail apparatus according to claim 11, the slide rail apparatus being configured to connect the panel and the fixing base.

15. The slide rail apparatus according to claim 11, wherein the first sliding piece is provided with a first chute, and at least part of the slide rail is in sliding fit with the first chute.

16. The slide rail apparatus according to claim 15, wherein the second sliding piece is provided with a second chute, and part of the slide rail is in sliding fit with the second chute.

17. The slide rail apparatus according to claim 15, wherein the slide rail is provided with a third chute, and the second sliding piece is slidably arranged in the third chute.

18. The slide rail apparatus according to claim 16, wherein the slide rail comprises a first body and a second body which are connected, wherein the first body is in sliding fit with the first chute, and the second body is in sliding fit with the second chute.

19. The slide rail apparatus according to claim 18, wherein the first body and the second body are staggered in a height direction of the slide rail.

20. The slide rail apparatus according to claim 11, wherein the slide rail assembly comprises a plurality of first sliding pieces which are sequentially nested, any two adjacent first sliding pieces being in sliding fit; and/or,
the slide rail assembly comprises a plurality of second sliding pieces which are sequentially nested, any two adjacent second sliding pieces being in sliding fit.
